(19) United States
(12) Patent Application Publication
(10) Pub. No.: US 2012/0068900 A1
(43) Pub. Date: Mar. 22, 2012

(54) Dielectric Waveguide Slot Antenna

(75) Inventors: Yukikazu YATABE, Tsurugashima-shi (JP); Kazuhiro Ito, Tsurugashima-shi (JP)

(73) Assignee: TOKO,INC., Tsurugashima-shi (JP)

(21) Appl. No.: 13/236,236

(22) Filed: Sep. 19, 2011

(30) Foreign Application Priority Data
Sep. 17, 2010 (JP) 2010-208977

(51) Int. Cl. H01Q 13/18

(52) U.S. Cl. 343/767

(57) ABSTRACT

A dielectric waveguide slot antenna which is capable of radiating a circularly-polarized wave comprises: a dielectric waveguide having a slot through which a dielectric is exposed in a part of an electrically conductive film formed on a surface of the dielectric waveguide; a printed circuit board having a via hole opposed to the slot with the same shape as that of the slot; and a conductor plate having a first through-hole opposed to and having approximately the same shape as the via hole, and a pair of second through-holes in a vicinity of the first through-hole. The dielectric waveguide, the printed circuit board and the conductor plate are joined together with aligning the slot, the via hole and the first through-hole with each other. The printed circuit board has a conductor layer formed in positions facing to the second through-holes, and the second through-holes are arranged point-symmetrically with each other.

### TECHNICAL FIELD

The present invention relates to a slot antenna designed to be fed by a dielectric waveguide in microwave and millimeter-wave bands, and, more specifically, to a dielectric waveguide slot antenna capable of radiating a circularly-polarized wave with a simple structure.

### BACKGROUND ART

As an antenna utilizing a dielectric waveguide as one type of transmission line, a dielectric waveguide slot antenna has been proposed. The dielectric waveguide slot antenna is suitable for use in microwave and millimeter-wave bands. FIG. 9 is an exploded perspective view illustrating a conventional dielectric waveguide slot antenna.

As illustrated in FIG. 9, the conventional dielectric waveguide slot antenna comprises a dielectric waveguide 100 having a slot 110 through which a dielectric is exposed from a bottom surface thereof. The dielectric waveguide 100 is mounted on a printed circuit board 200 formed with a via hole 210 having approximately the same shape as that of the slot 110 at a position opposed to the slot 110, and a conductor plate 300 having a first through-hole 310 at a position opposed to the via hole 210 is joined to the printed circuit board 200.

The conventional dielectric waveguide slot antenna illustrated in FIG. 9 is structurally simple, and capable of obtaining wideband characteristics even based on a single slot, so that it has high availability.

### PRIOR ART DOCUMENTS

### Patent Documents

Patent Document 1: JP 2004-221714A
Patent Document 2: JP 03-173204A

### SUMMARY OF THE INVENTION

### Problem to be Solved by the Invention

Generally, in terms of polarized wave dependence, receiving sensitivity is less likely to depend on a circularly-polarized wave as compared with a linearly-polarized wave. Thus, in use for a device in which a receiving position is continually changed, such as a mobile communication terminal, it is desirable to utilize a circularly-polarized wave, rather than a linearly-polarized wave. However, the dielectric waveguide slot antenna illustrated in FIG. 9 has a restriction that it is capable of radiating only a linearly-polarized wave.

As means to allow a slot antenna to radiate a circularly-polarized wave, there have been known a technique of combining two or more antennas different in direction and phase of a polarized wave, and a technique of providing a plurality of slots in a waveguide.

The above techniques leads to the following problems: an increase in size of an antenna system, associated with formation of a feeder circuit such as a branch circuit, and an increase in size of a waveguide due to a need for antenna array. Thus, they have difficulty in applying to a device requiring reductions in weight, thickness and cost, such as a mobile communication terminal, which hinders widespread use of a waveguide-type circularly-polarized antenna.

The present invention is directed to providing a dielectric waveguide slot antenna capable of radiating a circularly-polarized wave with a simple structure.

### Means for Solving the Problem

In order to solve the above problems, according to one aspect of the present invention, there is provided a dielectric waveguide slot antenna which comprises: a dielectric waveguide having a slot through which a dielectric is exposed in a part of an electrically conductive film formed on a surface of the dielectric waveguide; a printed circuit board having a via hole formed therein at a position opposed to the slot, the via hole having approximately the same shape as that of the slot; and a conductor plate having a first through-hole formed therein at a position opposed to the via hole, and a pair of second through-holes in a vicinity of the first through-hole, wherein: the dielectric waveguide, the printed circuit board and the conductor plate are joined together with aligning the slot, the via hole and the first through-hole with each other; the printed circuit board has a conductor layer formed in positions facing to the second through-holes; and the second through-holes are arranged point-symmetrically with each other with respect to the center of the first through-hole, and rotated with respect to the longitudinal direction of the first through-hole.

### Effect of the Invention

The dielectric waveguide slot antenna of the present invention is capable of radiating a circularly-polarized wave with a simple structure prepared by stacking the dielectric waveguide, the printed board and the conductor plate together and forming the plurality of through-holes in the conductor plate, so that it can be offered for use in a device requiring reductions in weight and thickness, such as a mobile communication terminal.

### BRIEF DESCRIPTION OF THE DRAWINGS

FIG. 1 is an exploded perspective view illustrating a structure of a dielectric waveguide slot antenna according to one embodiment of the present invention.

FIG. 2 illustrates an operation of the dielectric waveguide slot antenna according to the embodiment.

FIG. 3 is a top plan view illustrating a first through-hole and second through-holes.

FIG. 4 is a graph illustrating an axial ratio in a zenith direction, depending on a rotation angle θ2 of the second through-hole, in an inventive example.

FIG. 5 is a graph illustrating an axial ratio in the zenith direction, depending on a distance D between the first through-hole and the second through-hole, in an inventive example.

FIG. 6 is a graph illustrating an axial ratio in the zenith direction, depending on a length L2 of the second through-hole, in an inventive example.

FIG. 7 graphically illustrates radiation characteristics of a dielectric waveguide slot antenna in an inventive example.

FIG. 8 illustrates other embodiments of the present invention.

FIG. 9 is an exploded perspective view illustrating a conventional dielectric waveguide slot antenna.

### DESCRIPTION OF EMBODIMENTS

A dielectric waveguide slot antenna of the present invention will now be described based on an embodiment thereof

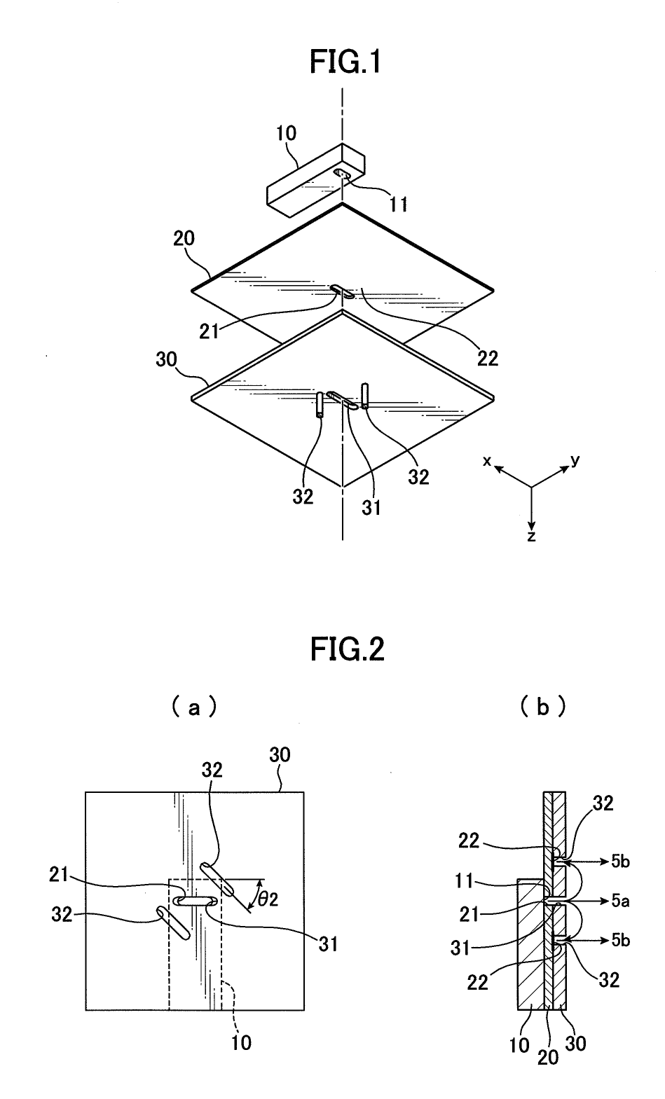

FIG. 1 is an exploded perspective view of a dielectric waveguide slot antenna according to one embodiment of the present invention.

As illustrated in FIG. 1, the dielectric waveguide slot antenna comprises a dielectric waveguide 10, a printed circuit board 20, and a conductor plate 30. The dielectric waveguide 10 comprises a dielectric, an electrically conductive film formed on a surface of the dielectric, and a slot 11 through which the dielectric is exposed from a part of the electrically conductive film. The printed circuit board 20 is formed with a via hole 21 having approximately the same shape as that of the slot 11 at a position opposed to the slot 11. The conductor plate 30 is formed with a first through-hole 31 having approximately the same shape as that of the via hole 21 at a position opposed to the via hole 21, and a pair of second through-holes 32, 32 in a vicinity of the first through-hole 31. The dielectric waveguide 10 is mounted on the printed circuit board 20 which is joined to conductor plate 30.

The slot 11 is provided such that a longitudinal direction thereof is oriented perpendicular to a longitudinal direction of the dielectric waveguide (propagation direction of an electromagnetic wave).

Each of the via hole 21 and the first through-hole 31 has approximately the same shape as that of the slot 11. However, in view of enhancing radiation efficiency with respect to a free space, it is preferable that the via hole 21 has a longitudinal length greater than a longitudinal length of the slot 11, and the first through-hole 31 has a longitudinal length greater than the longitudinal length of the via hole 21.

Each of the pair of second through-holes 32, 32 is an elongate hole, and they are arranged in point-symmetrical relation with respect to a center point of the first through-hole 31. A longitudinal direction of the second through-hole 32 is inclined at about 45° with respect to a longitudinal direction of the first through-hole 31, and a distance between the center of the first through-hole 31 and a center of the second through-hole 32 is less than a half wavelength of a frequency to be used.

The dielectric waveguide 10, the printed circuit board 20 and the conductor plate 30 are stacked and joined together in such a manner that the slot 11, the via hole 21 and the first through-hole 31 are aligned with each other in terms of their center positions and longitudinal directions.

The printed circuit board 20 has a conductor layer 22 formed in positions facing to the second through-holes.

FIG. 2 illustrates a principle of operation of the dielectric waveguide slot antenna according to the embodiment, wherein FIG. 2(a) is a top plan view, and FIG. 2(b) is a schematic sectional view.

In cases where the through-holes 31, 32, 32 are located adjacent to the slot 11, it is considered that a direct wave 5a directly radiated from the first through-hole 31 combines indirect waves 5b,5b which are a part of direct wave 5a reradiated from the second through-holes 32, 32 through the conductor layer 22 provided on a surface of the printed circuit board 20, so as to control directivity, as illustrated in FIG. 2(b).

Usually, in order to uniform respective polarization directions of the direct wave 5a and each of the indirect waves 5b so as to facilitate interference between the direct wave 5a and the indirect wave 5b, respective longitudinal directions of the second through-hole 32 and the slot 11 are arranged in parallel. Differently, in the dielectric waveguide slot antenna according to this embodiment, the longitudinal direction of the second through-hole 32 is disposed to be rotated by a rotation angle θ2 with respect to a longitudinal direction of the first through-hole 31, as illustrated in FIG. 2(a).

In cases where the longitudinal direction of the second through-hole 32 is not parallel to the longitudinal direction of the first through-hole 31, the indirect wave 5b to be reradiated from the second through-hole 32 is evaluated by resolving it into a component parallel to a polarized wave based on the direct wave 5a and a component perpendicular to the polarized wave based on the direct wave 5a. A combined wave is composed of the following two:
(a) a combination of “a component included in the indirect wave, parallel to the polarized wave based on the direct wave 5a” and “the direct wave”; and
(b) “a component included in the indirect wave, perpendicular to the polarized wave based on the direct wave 5a”.
   The two components (a) and (b) are perpendicular to each other. Thus, the combined wave can be formed as an optimal circularly-polarized wave by designing the antenna such that the components (a) and (b) have the same amplitude and a phase difference of 90°. An amplitude and phase of the indirect wave 5b are adjusted based, for example, on a shape and position of the second through-hole 32.

In cases where the longitudinal direction of the first through-hole 31 and the longitudinal direction of the second through-hole 32 are perpendicular to each other (θ2=−90° or 90°), or parallel to each other (θ2=0°), no component parallel or perpendicular to the polarized wave based on the direct wave is included in the indirect wave, so that the combined wave is not formed as a circularly-polarized wave. Preferably, θ2 is set to 45° or −45°.

A rotation direction of a circularly-polarized wave is determined by a direction of the rotation angle θ2 of the second through-hole 32. On an assumption that a clockwise direction when seeing the conductor plate 30 from a radiation direction is a positive direction, and −90°<θ2<90°, a right-handed circularly-polarized wave is formed when θ2>0, and a left-handed circularly-polarized wave is formed when θ2<0.

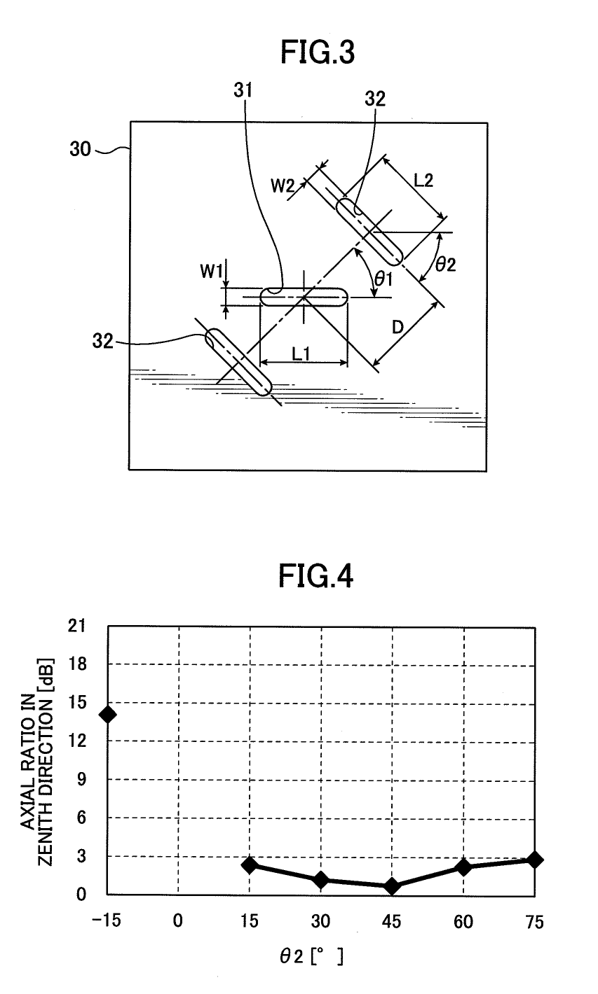

FIG. 3 is a top plan view illustrating respective positions of the first through-hole 31 and the second through-holes 32, 32 arranged in the conductor plate 30.

As illustrated in FIG. 3, the pair of second through-holes 32, 32 are arranged in point-symmetrical relation with respect to the center point of the first through-hole 31. The first through-hole 31 is a linear-shaped elongate hole having a length L1×a width W1, and each of the second through-holes 32 is a linear-shaped elongate hole having a length L2×a width W2. The second through-hole 32 has a center point which is rotated by a rotation angle θ1 with respect to the longitudinal direction of the first through-hole 31 and spaced apart from the center point of the first through-hole 31 by a distance D. Further, the second through-hole 32 is rotated about the center point of the second through-hole 32 by the rotation angle θ2 with respect to the longitudinal direction of the first through-hole 31.

### Example 1

The dielectric waveguide slot antenna was prepared under the following conditions.

A size of the dielectric waveguide 10: width 2.5 mm×height 1.2 mm×length 10 mm

A relative permittivity ∈r of a dielectric material: 2.31

A position of the slot 11: 1.8 mm from an end of the dielectric waveguide

A size of the slot: length 2.1 mm×width 1.0 mm

A size of the conductor plate 30: length 20 mm×width 20 mm×thickness 1.0 mm

A size of the printed circuit board 20: length 20 mm×width 20 mm×thickness 0.2 mm

A size of the first through-hole 31: L1×W1=2.7 mm×1.0 mm

A size of the second through-hole 32: L2×W2=3.8 mm×1 mm The rotation angle θ1 of the second through-hole 32 with respect to the first through-hole 31: 45°

The distance D between the second through-hole 32 and the first through-hole 31: 1.95 mm

FIG. 4 is a result obtained by calculating an axial ratio in a zenith direction using an electromagnetic simulator, when the rotation angle θ2 of the second through-hole 32 is changed under the above conditions. In FIG. 4, the horizontal axis represents the rotation angle θ2, and the vertical axis represents the axial ratio [dB] in the zenith direction. A frequency used is 61 GHz.

As seen in FIG. 4, a right-handed circularly-polarized wave having an optimal axial ratio was obtained when θ2=about 45°.

### Example 2

FIG. 5 is a result obtained by calculating an axial ratio in the zenith direction using an electromagnetic simulator, when the rotation angle θ2 of the second through-hole 32 is fixed to 45°, and the distance D of the second through-hole 32 with respect to the first through-hole 31 is changed, differently from Example 1. The remaining conditions are the same as those in Example 1. In FIG. 5, the horizontal axis represents a ratio of the distance D/a wavelength λ, and the vertical axis represents the axial ratio [dB] in the zenith direction.

As seen in FIG. 5, an axial ratio characteristic is sharply deteriorated when the distance D of the second through-hole 32 with respect to the first through-hole 31 becomes greater than 0.5 times the wavelength λ of the frequency used.

### Example 3

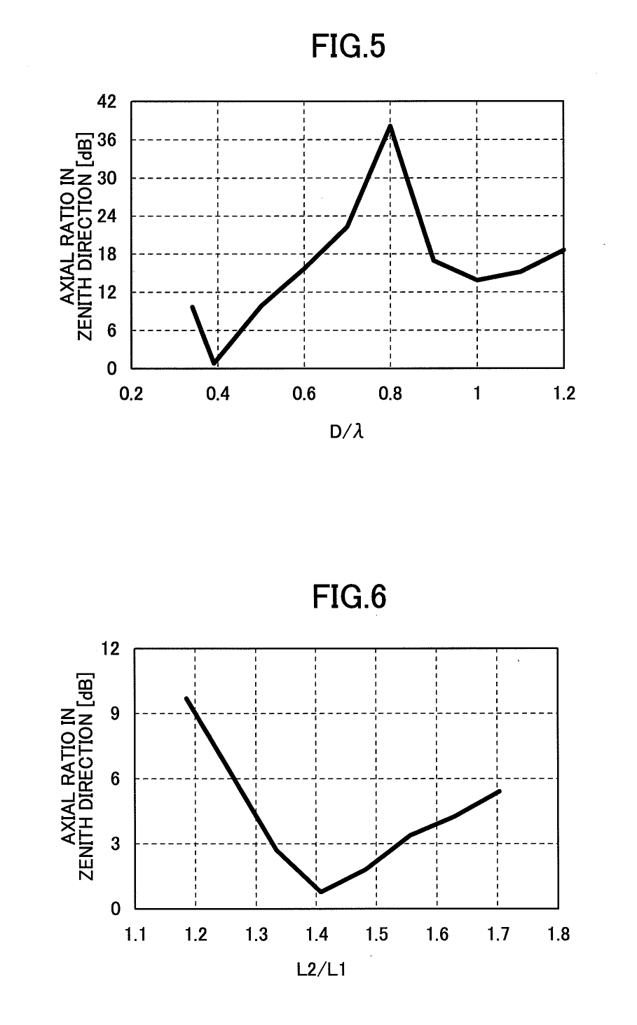

FIG. 6 is a result obtained by calculating an axial ratio in the zenith direction using an electromagnetic simulator, when the rotation angle θ2 of the second through-hole 32 is fixed to 45°, and the length L2 of the second through-hole 32 is changed, differently from Example 1. The remaining conditions are the same as those in Example 1. In FIG. 6, the horizontal axis represents a ratio of the longitudinal length L2 of the second through-hole 32/the longitudinal length L1 of the first through-hole 31, and the vertical axis represents the axial ratio [dB] in the zenith direction.

As seen in FIG. 6, an optimal axial ratio can be obtained when the longitudinal length L2 of the second through-hole 32 is about 1.4 times the longitudinal length L1 of the first through-hole 31.

### Example 4

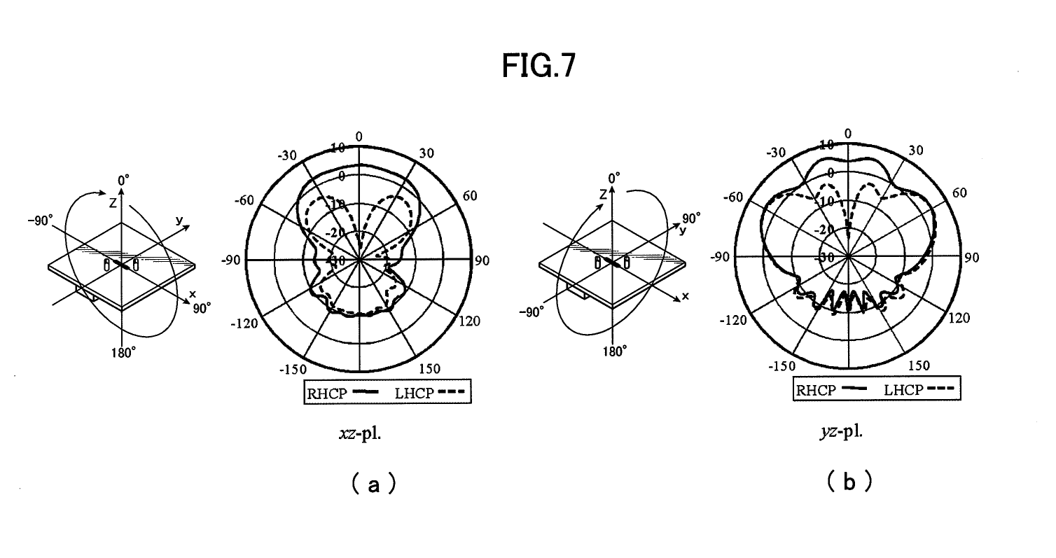

FIG. 7 is a result obtained by calculating radiation characteristics using an electromagnetic simulator, when the rotation angle θ2 of the second through-hole 32 is fixed to 45°, and the rotation angle θ2 of the second through-hole 32 is changed, differently from Example 1. The remaining conditions are the same as those in Example 1.

FIG. 7(a) illustrates a right-handed circularly-polarized wave (RHCP) and a left-handed circularly-polarized wave (LHCP) on an X-Z plane, and FIG. 7(b) illustrates a right-handed circularly-polarized wave (RHCP) and a left-handed circularly-polarized wave (LHCP) on a Y-Z plane, on an assumption that a surface of the conductor plate 30 is an X-Y plane, and the longitudinal direction of the first through-hole 31 and a radiation direction of an electromagnetic wave are an X-axis direction and a Z-axis direction, respectively.

As seen in FIG. 7, an excellent circularly-polarized wave can be obtained.

As is evidenced from the results of Examples 1 to 4, a dielectric waveguide slot antenna capable of obtaining an optimal circularly-polarized wave is provided by: arranging the second through-holes 32, 32 in point-symmetrical relation with respect to the center point of the first through-hole 31 while being rotated by about 45° with respect to the longitudinal direction of the first through-hole 31; setting the distance between the center point of the first through-hole 31 and the second through-hole 32, to a value less than a half wavelength of a frequency to be used; and setting the longitudinal length of the second through-hole 32 to a value about 1.4 times the longitudinal length of the first through-hole 31.

In Examples 1 to 4, the second through-hole 32 was disposed to have a rotation angle θ2 of 45°, so that a right-handed circularly-polarized wave was obtained. When the second through-hole 32 is disposed to have a rotation angle θ2 of −45°, a left-handed circularly-polarized wave is obtained.

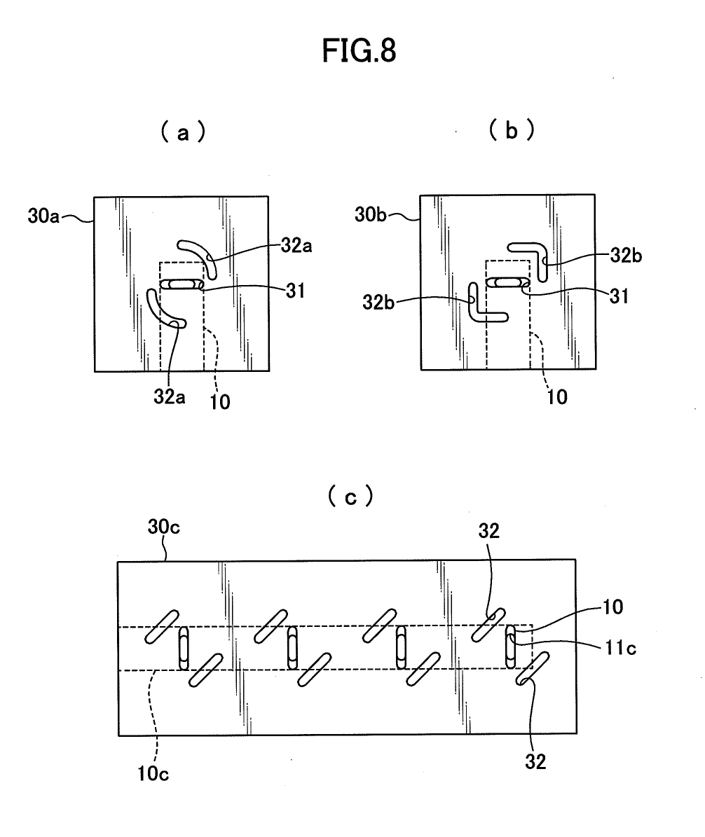

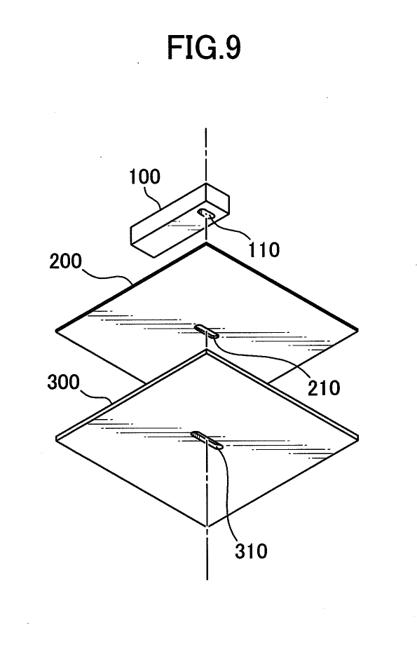

The second through-hole is not limited to a linear-shaped elongate hole, but may be an arc-shaped or bended elongate hole. FIG. 8 illustrates other embodiments of the present invention.

The second through-hole may be formed as an arc-shaped second through-hole 32a, as illustrated in FIG. 8(a), or a dogleg-shaped second through-hole 32b, as illustrated in FIG. 8(b). In this case, an area occupied by the second through-hole on the conductor plate can be reduced. Further, as illustrated in FIG. 8(c), a plurality of slots 11c may be provided in a dielectric waveguide, and a first through-hole 31c and a second through-hole 32c may be provided in a conductor plate 30c in an array arrangement. In this case, a gain and directivity of a dielectric waveguide slot antenna can be enhanced.

The conductor plate may be replaced, for example, by a printed circuit board, or a metal-plated resin plate. Each of the second through-holes may be a groove which does not penetrate through the conductor plate. In this case, a combined wave can also be formed as a circularly-polarized wave, because an indirect wave is reflected by a bottom of the groove.

The dielectric waveguide slot antenna of the present invention can be obtained simply by modifying a structure of a conventional dielectric waveguide slot antenna, so that a conventional dielectric waveguide can be used therefor. This makes it possible to provide a dielectric waveguide slot antenna for a circularly-polarized wave while suppressing a production cost, without a need for designing a dielectric waveguide for circularly-polarized waves, separately from a dielectric waveguide for linearly-polarized waves.

### EXPLANATION OF REFERENCES

10, 100: dielectric waveguide
11, 11c, 110: slot
20, 200: printed circuit board
21, 210: via hole
22: conductor layer
30, 30a to 30c, 300: conductor plate
31, 310: first through-hole
32, 32a to 32c: second through-hole
5a: direct wave
5b: reflected wave

What is claimed is:

1. A dielectric waveguide slot antenna comprising:
a dielectric waveguide having a slot through which a dielectric is exposed in a part of an electrically conductive film formed on a surface of the dielectric waveguide;
a printed circuit board having a via hole formed therein at a position opposed to the slot, the via hole having approximately the same shape as that of the slot; and
a conductor plate having a first through-hole formed therein at a position opposed to the via hole, and a pair of second through-holes formed in a vicinity of the first through-hole, the first through-hole having approximately the same shape as that of the via hole, wherein:
the dielectric waveguide, the printed circuit board and the conductor plate are joined together with aligning the slot, the via hole and the first through-hole with each other;
the printed circuit board has a conductor layer formed in positions facing to the second through-holes; and
the second through-holes are arranged point-symmetrically with each other with respect to the center of the first through-hole, and rotated with respect to the longitudinal direction of the first through-hole.

2. The dielectric waveguide slot antenna as defined in claim 1, wherein a rotation angle of each of the second through-holes is about 45° with respect to the longitudinal direction of the first through-hole.

3. The dielectric waveguide slot antenna as defined in claim 1, wherein the second through-holes have a longitudinal length of about 1.4 times as long as a longitudinal length of the first through-hole.

4. The dielectric waveguide slot antenna as defined in claim 1, wherein the second through-holes are disposed away from the center of the first through-hole by a distance less than a half of the wavelength of a frequency to be used.

5. The dielectric waveguide slot antenna as defined in claim 1, wherein the via hole has a longitudinal length larger than a longitudinal length of the slot, and the first through-hole has a longitudinal length larger than the longitudinal length of the via hole.

6. A dielectric waveguide slot antenna comprising:
a dielectric waveguide having a slot through which a dielectric is exposed in a part of an electrically conductive film formed on a surface of the dielectric waveguide;
a printed circuit board having a via hole formed therein at a position opposed to the slot, the via hole having approximately the same shape as that of the slot; and
a conductor plate having a through-hole formed therein at a position opposed to the via hole, and a pair of grooves in a vicinity of the through-hole, the through-hole having approximately the same shape as that of the via hole, wherein:
the dielectric waveguide, the printed circuit board and the conductor plate are joined together with aligning the slot, the via hole and the through-hole with each other; and
the grooves are arranged point-symmetrically with each other with respect to the center of the through-hole, and rotated with respect to a longitudinal direction of the through-hole.

7. The dielectric waveguide slot antenna as defined in claim 6, wherein a rotation angle of each of the grooves is about 45° with respect to the longitudinal direction of the through-hole.

8. The dielectric waveguide slot antenna as defined in claim 6, wherein the grooves have a longitudinal length of about 1.4 times as long as a longitudinal length of the through-hole.

9. The dielectric waveguide slot antenna as defined in claim 6, wherein the grooves are disposed away from the center of the through-hole by a distance less than a half of the wavelength of a frequency to be used.

10. The dielectric waveguide slot antenna as defined in claim 6, wherein the via hole has a longitudinal length larger than a longitudinal length of the slot, and the through-hole has a longitudinal length larger than the longitudinal length of the via hole.
